(19) United States
(12) Patent Application Publication
(10) Pub. No.: US 2026/0172252 A1
(43) Pub. Date: Jun. 18, 2026

(54) IDENTITY AUTHENTICATION METHOD BASED ON COVERT CHANNEL, APPARATUS THEREOF AND APPLICATION THEREOF

(71) Applicant: BEIJING JIAOTONG UNIVERSITY, Beijing (CN)

(72) Inventors: Wei QUAN, Beijing (CN); Yuming ZHANG, Beijing (CN); Jun DENG, Beijing (CN); Mingyuan LIU, Beijing (CN); Yuguo SHAN, Beijing (CN); Xue ZHANG, Beijing (CN); Yan LUO, Beijing (CN); Jinfa WANG, Beijing (CN); Wei SU, Beijing (CN); Deyun GAO, Beijing (CN); Hongke ZHANG, Beijing (CN)

(73) Assignee: BEIJING JIAOTONG UNIVERSITY, Beijing (CN)

(21) Appl. No.: 19/304,669

(22) Filed: Aug. 20, 2025

(30) Foreign Application Priority Data
Dec. 12, 2024 (CN) 202411829131.0

(51) Int. Cl. H04L 9/32; H04L 9/08

(52) U.S. Cl. CPC H04L 9/3215; H04L 9/085; H04L 9/0891

(57) ABSTRACT

An identity authentication method based on a covert channel, an apparatus thereof and an application thereof are provided. The identity authentication method includes: transmitting user identity information used for authentication in a covert channel or an overt channel, and generating misleading or even induced forged identity information for confused transmission in the channel; then dividing a key and transmitting the key in two channels, so that key management ability is enhanced, and difficulty of key interception is greatly improved; and in an encrypted communication stage, embedding some short tag information in the covert channel to continuously authenticate a client. The covert channel is also used to renegotiate about replacing the key when transmitting a certain amount of data or important information, thus improving security of communication data. Finally, a method of constructing a covert channel based on the order of the inter-packet delays is further provided.

### CROSS-REFERENCE TO THE RELATED APPLICATIONS

This application is based upon and claims priority to Chinese Patent Application No. 202411829131.0, filed on Dec. 12, 2024, the entire contents of which are incorporated herein by reference.

### TECHNICAL FIELD

The present disclosure relates to the technical field of communication, in particular to a problem of reliable identity authentication in the technical field of communication, and in particular to an identity authentication method based on a covert channel, an apparatus thereof and an application thereof.

### BACKGROUND

Communication data information of users is extremely vulnerable to interception, eavesdropping, and tampering by attackers, so that an identity authentication method must be used to authenticate legitimacy of identities of both communication parties, thus ensuring security of communication data. In the prior art, encryption means are mostly used for secure communication, and a session key is generated through user authentication, key negotiation and other processes to encrypt subsequent communication data content, thus providing safe and reliable communication services. However, with the development of computing power, the key becomes easier to be cracked, and a key that is too complex will consume a large amount of resources and reduce efficiency. On the other hand, the field of identity authentication still only uses an overt channel to transmit a key, user identities and other important and sensitive information, and the information will still be intercepted, eavesdropped and tampered by attackers because of open characteristics of the overt channel, which will easily expose privacy of users.

Compared with the overt channel, a network covert channel is a technology that uses network characteristics to embed information to establish a covert communication channel and transmit data using the covert communication channel. The covert channel is classified into covert storage channels and covert timing channels. For example, information may be embedded for covert transmission by altering the data packet delay interval to represent different bits. A longer data packet time interval of the network represents a bit “1”, and a shorter data packet time interval represents a bit “0”. Another covert storage channel can embed information in a data unit and a protocol header by change the data packet length. For example, information is embedded in some fields of an Internet Protocol (IP) header and a Transmission Control Protocol (TCP) header. The covert storage channel is large in capacity, good in robustness and little in influence when the network state changes, but poor in covertness and easy to be detected. However, the covert timing channel is good in covertness and difficult to be detected, but small in channel capacity, which is easily affected by the change of the network state and is low in robustness.

To sum up, if the existing technology only focuses on a longer key and a more complex encryption algorithm, the existing technology will still face problems such as channel public exposure, key distribution management, and large calculation overhead.

### SUMMARY

An objective of the present disclosure is to provide an identity authentication mechanism based on a covert channel, which provides a stricter authentication system for a client and a server. In view of shortcomings of the existing identity authentication mechanism in the background, the combination of identity authentication and a covert channel makes up for the above shortcomings, which provides a new solution for authentication and encryption and improves security of a communication process. The present disclosure is no longer limited to using an overt channel to transmit all information such as a user identity, a key, data, etc., but combines the overt channel with the covert channel to finally achieve safer and more reliable identity authentication and ensure the communication security of the whole process through continuous authentication.

A first aspect of the present disclosure provides an identity authentication method based on a covert channel, which includes following steps.

First, user identity information (including identity authentication information, key information, key parameters, and other important information for the authentication process) used for authentication is transmitted in a covert channel, and misleading or even induced forged identity information is generated for transmission in an overt channel concurrently, so that an attacker can only intercept false identity information and communication data, thereby achieving a purpose of privacy protection. By extension, the true and false identity information may be transmitted randomly in the overt channel and the covert channel, and the receiver only needs to authenticate a piece of true identity information. In this way, it is no longer fixed that certain information must be transmitted through a specific channel, which may better ensure data privacy and security. Then, the key and the parameters of the key are divided and transmitted in two channels, which increases the security of key transmission and enhances key management ability. In order to obtain the key, attackers must intercept all the information of the two channels, and also know a key recombination and recovery rule, which greatly improves the difficulty of key interception and makes up for the shortcomings in the security guarantee of key transmission in identity authentication. In the final encrypted communication stage, some short tag information is embedded in the covert channel to continuously authenticate a client, so as to ensure security of a whole communication process. In addition, the covert channel is also used to renegotiate about replacing the key when transmitting a certain amount of data or important information, thus improving security of communication data.

A second aspect of the present disclosure provides an apparatus of identity authentication based on a covert channel, including an identity authentication client and an identity authentication server, where a covert channel and an overt channel are constructed between the identity authentication client and the identity authentication server;
the covert channel and the overt channel are configured to transmit user identity information for authentication and misleading forged identity information; and transmit divided key, respectively; and
the covert channel is further configured to transmit short tag information for continuous authentication.

In an embodiment, the identity authentication client and the identity authentication server each include an identity information hiding module, a key transmission module, a continuous authentication module, a covert information embedding module and a covert information extraction module;
the identity information hiding module, the key transmission module and the continuous authentication module are responsible for generating required corresponding information, determining which channel to be used for transmitting corresponding information and a next task execution scheme after receiving the information; and the covert information embedding module are configured to embed the information into the covert channel, and the covert information extraction module are configured to extract the information from the covert channel.

In an embodiment, the identity information hiding module is configured to generate false identity information and false key parameter information and generate a key encoding or dividing rule.

In an embodiment, the identity authentication client and the identity authentication server cooperate as follows to complete identity authentication.

In initialization stage, the client establishes communication connection with the server, sends an identity authentication request to the server, transmits the user identity information to be used for authentication by using the covert information embedding module in the covert channel, and transmits identity information forged by the identity information hiding module and false key parameter information in the overt channel. Further, one from the overt channel and the covert channel is randomly selected to transmit true or false identity information, and the server only needs to authenticate a piece of complete true identity information. In this way, it is no longer fixed that certain information must be transmitted through a specific channel. User information may be transmitted by a dividing or confusing method, which may better ensure privacy and security of data.

Identity authentication stage is used to achieve identity authentication between the client and the server. The server authenticates the identity information of the client after receiving the authentication request, and checks whether the client is registered, and if the client is not registered, the client is deemed as an unauthorized user and authentication fails; if the identity information is valid, the authentication is successful, then the server uses the key transmission module to generate false communication information and a true key parameter, and then the true key parameter is divided according to the key encoding or dividing rule received from the client before to obtain two divided key parameters for transmission.

In key exchange stage, after receiving the two divided key parameters from the two channels, the client decodes and recovers the key according to the key encoding or dividing rule to obtain a communication session key for a subsequent communication session; the key used for communication session is divided according to the key encoding or dividing rule to obtain two divided communication session keys, and the two divided communication session keys are transmitted in the overt channel and the covert channel, respectively.

In encrypted communication stage, after receiving all the information, the server restores and splices the two divided communication session keys into a communication key according to the key encoding or dividing rule; and then, the server and the client use the communication key as the communication session key to perform encrypted communication transmission on data in the overt channel.

In an embodiment, in the encrypted communication stage, the continuous authentication module is further configured to generate a short tag as a subsequent lightweight authentication identifier, and then upon entering a continuous authentication stage, and after receiving the short tag, the client embeds the short tag in the covert channel and transmits the short tag with data in the overt channel at the same time; at this time, if an attacker attempts to join in a communication process to carry out man-in-the-middle attack, forgery attack, etc., this attempt is perceived and warned by the continuous authentication module when the attacker establishes communication connection with the client and the server since the covert channel used by the attacker does not contain the short tag.

In an embodiment, an information transmission path may be changed to a situation in which the overt channel is configured to transmit the user identity information to be used for authentication and the covert channel is configured to transmit the misleading forged identity information.

A third aspect of the present disclosure provides a method for constructing a covert channel based on an order of inter-packet delays, which includes: establishing a covert channel to embed information for transmission data by adjusting the order of the inter-packet delays, which is different from other covert channel methods. This method does not change an absolute size of the delay between the data packets, a time slot centroid, etc., keeps the original sequence characteristics, and changes a relative size through an exchange sequence to carry the information embedding data.

The present disclosure further provides an application of the method or apparatus, such as an application of identity authentication of a drone and an application of identity authentication on a File Transfer Protocol (FTP) platform.

The technical scheme of the present disclosure has the following technical effects.

(1) User identity information is protected. According to the present disclosure, identity information in the authentication process is transmitted in one channel, and misleading or induced false identity information is transmitted in another channel, so that attackers cannot distinguish authenticity, thereby achieving an effect of protecting identity privacy of users.

(2) Key management is enhanced, and security of key transmission is enhanced. According to the present disclosure, the key is divided into two parts for transmission. Attackers must intercept the information of two channels at the same time, and can only restore the key information completely when knowing the key recombination and recovery rule, which greatly improves the difficulty of key interception and makes up for the shortcomings in the security guarantee of key transmission in identity authentication.

(3) Reliability of identity authentication is improved. The present disclosure uses a covert channel and an overt channel to jointly transmit important information such as user identity information and a communication key, and combines the advantages of the covert channel with identity authentication, thus providing a stricter and more reliable identity authentication scheme.

(4) Security of the whole communication process is improved. In the encrypted communication stage, the present disclosure can still choose to embed a short tag in the covert channel for authentication, so as to ensure the security of the whole communication process. Once subjected to attacks such as interception, forgery, or man-in-the-middle attack, the covert channel authentication will be affected. In order to ensure communication of high reliability and high security, this manner may be selected to ensure security of the whole communication process with less overhead.

(5) A covert information embedding algorithm based on the order of the inter-packet delays provided by the present disclosure can embed information only by adjusting the order of the inter-packet delays without changing its absolute size, so that the capacity of the covert channel and the covertness reduces are increased, the overhead is decreased.

### BRIEF DESCRIPTION OF THE DRAWINGS

The attached drawings, which constitute a part of the present disclosure, are used to provide a further understanding of the present disclosure. The illustrative embodiments of the present disclosure and their descriptions are used to explain the present disclosure, and do not constitute undue limitations on the present disclosure. In the attached drawings:

FIG. 1 shows an overall architecture diagram of the present disclosure;

FIG. 2 shows a flow diagram of completing identity authentication according to the present disclosure;

FIG. 3 shows a diagram of authentication of drone deployment in a smart city scene to which the present disclosure is applied; and

FIG. 4 shows a schematic diagram of identity authentication of an FTP platform to which the present disclosure is applied.

### DETAILED DESCRIPTION OF THE EMBODIMENTS

It should be noted that the embodiments in the present disclosure and the features in the embodiments may be combined with each other without conflict. The present disclosure will be described in detail with reference to the attached drawings and embodiments.

### Embodiment 1

An embodiment of the present disclosure provides an identity authentication method based on a covert channel. Most authentication schemes include five stages: initialization, client-server identity authentication, key negotiation, encrypted communication, and continuous authentication. This embodiment may be combined with many different identity authentication schemes, work on the basis of five stages, use a covert channel to achieve user privacy protection and key protection, and ensure communication security. Specifically, a covert channel and an overt channel are used to perform confused transmission on true user identity information and a key, and attackers must decode the information of the two channels to obtain the user identity, the key and the communication data completely, which can protect the user identity privacy, security of key transmission and security of communication authentication.

Initialization stage of the identity authentication method based on the covert channel is used for the client to initiate an identity authentication request and generate a key parameter to prepare for key negotiation and subsequent encrypted communication. The client transmits true identity information and key parameter information in one of the covert channel and the overt channel, and then transmits false identity information and key parameter information in the other channel. Using the overt channel and the covert channel to perform divided and confused transmission on the true and false information, attackers cannot determine which channel to transmit the true information. Even if all the channel information is intercepted, the attackers cannot determine whether the information is true or false, and the attackers may even be misled by false information, so the attackers cannot launch an attack.

Client-server identity authentication stage is used to achieve identity authentication between the client and the server. The server authenticates the identity information of the client after receiving the authentication request, and checks whether the client is registered. If the client is not registered, the client is deemed as an unauthorized user. If the identity information is valid, some false communication information is generated. For example, a false key and false task information are transmitted in an overt channel, and the true key parameter is divided and transmitted in two channels according to a specific rule, which increases the difficulty for attackers to crack the key and enhances the security of key transmission.

Key exchange stage is used to achieve key exchange and negotiation between the client and the server, and determine the key for subsequent encrypted communication. After receiving the true key parameter mentioned above, the server calculates to obtain the key, and continues to divide the key into two sections and transmit the two sections in two channels, respectively, which increases the difficulty for attackers to crack the key and enhances the security of key transmission.

Encrypted communication stage is used for both communication parties to recover and obtain the complete key and continue encrypted communication for data transmission. In this stage, a short tag is generated for subsequent lightweight authentication in the communication process to ensure the communication security of the whole process.

In continuous authentication stage, a short tag is embedded in the covert channel to perform continuous lightweight authentication on the client. Moreover, in this stage, a key replacement rule can also be used to replace the key when a certain amount of data is transmitted or when important information is about to be transmitted. It must be emphasized that the present disclosure does not mean that it only contains five stages for identity authentication, nor does it focus on how identity information is encrypted and how the key is generated. The focus of the present disclosure is to enhance identity authentication in the transmission process using the covert channel. Therefore, the present disclosure may be combined with many different identity authentication schemes and flexibly deployed according to different scenes and requirements. That is, corresponding modules and stages may be reduced according to user overhead and required functions, and other methods such as key calculation and encrypted communication can also be applied. The present disclosure may be independently deployed and applied to identity authentication, and can also be deployed in the five stages of the traditional authentication algorithm to work. By using the present disclosure, privacy protection, key transmission protection and continuous authentication may be provided, providing highly reliable identity authentication without affecting the uniqueness and innovation of the identity authentication mechanism of the present disclosure.

An algorithm of establishing a covert channel to embed key information based on an order of the inter-packet delays is also included. The core idea of the algorithm is to establish a covert channel to embed information for data transmission by adjusting the order of the inter-packet delays without changing an absolute value of sequence of the inter-packet delays. It must be emphasized that the present disclosure provides a method of establishing a covert channel based on the order of the inter-packet delays, which does not mean that only if the above-mentioned identity authentication process uses this method to establish a covert channel, the identity authentication mechanism can work normally. There are various technologies for establishing a covert channel, which may be applied to the above-mentioned identity authentication process, without being limited to a certain covert channel information embedding method, but may be embedded with various methods to establish a covert channel to embed hidden information. Moreover, the technologies for establishing a covert channel may be flexibly deployed in the covert information embedding module and the covert information extraction module according to different scenes and overhead without affecting the uniqueness and innovation of the identity authentication mechanism.

### Embodiment 2

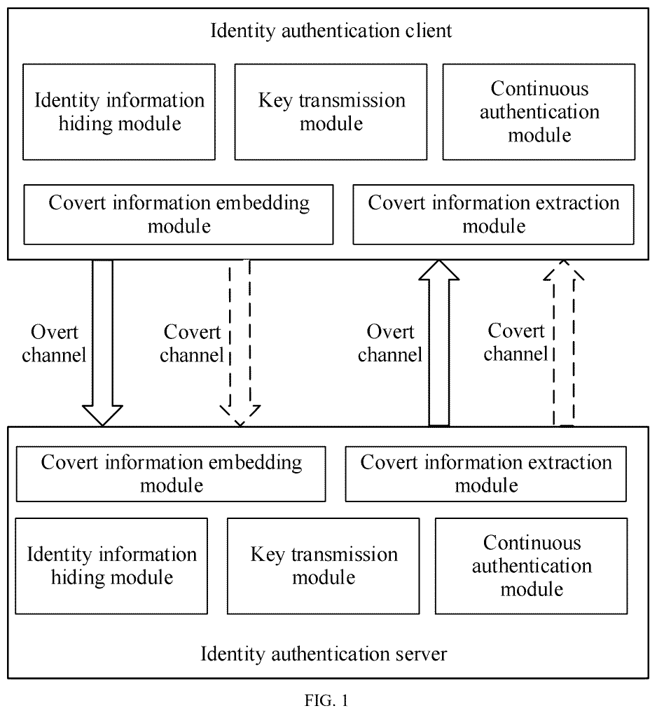

An embodiment of the present disclosure provides an identity authentication apparatus based on a covert channel. The overall architecture diagram of the present disclosure is shown in FIG. 1. The identity authentication client and server each consist of an identity information hiding module, a key transmission module, a continuous authentication module, a covert information embedding module and a covert information extraction module. The identity information hiding module, the key transmission module and the continuous authentication module are responsible for generating the required information, determining which channel to transmit the corresponding information and a next task execution scheme after receiving the information. By using corresponding methods, the covert information embedding module embeds the information into the covert channel, and the covert information extraction module extracts the information from the covert channel.

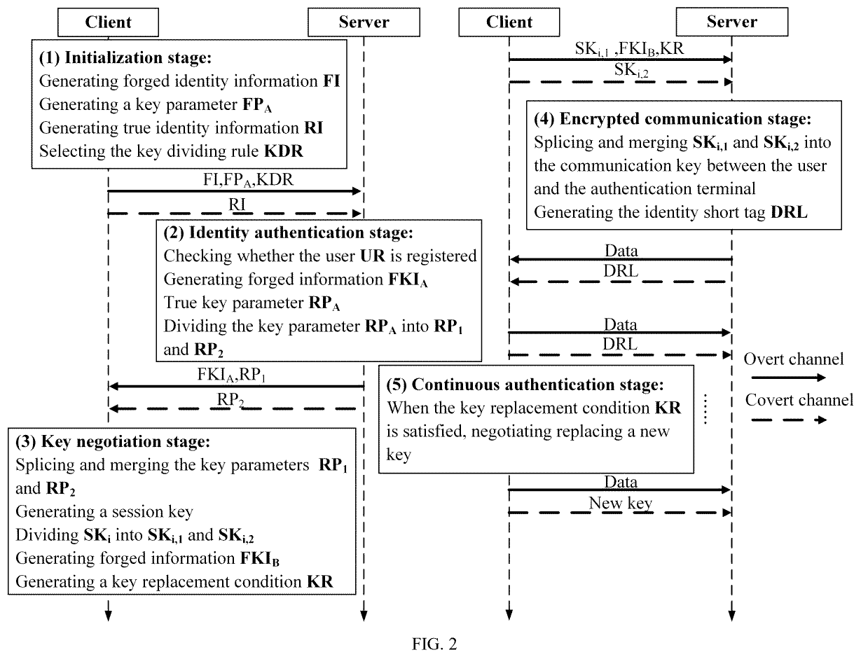

The flow diagram of identity authentication of the present disclosure is shown in FIG. 2. The identity authentication scheme can work in five stages, that is, (1) initialization stage, (2) client-server identity authentication stage, (3) key negotiation stage, (4) encrypted communication stage, and (5) continuous authentication stage. Before the identity authentication scheme runs, all the clients in the system have registered in the server, and the workflow of all stages is described in detail as follows. It should be noted that the present disclosure does not mean that it is limited to only containing five stages, nor does it focus on how identity information is calculated and encrypted and how the key is calculated and generated. The advantage of the present disclosure is to enhance identity authentication in the transmission process using the covert channel. Therefore, the present disclosure may be combined with many different identity authentication schemes and work on the basis of five stages. The application of the present disclosure provides privacy protection, key transmission protection and continuous authentication, and provides highly reliable identity authentication. Moreover, the identity authentication process proposed in this section of the present disclosure is not limited to a certain covert channel information embedding method, but may be embedded with various methods to establish a covert channel to embed hidden information. Moreover, the identity authentication process proposed in this section of the present disclosure may be flexibly deployed in the covert information embedding module and the covert information extraction module according to different scenes and overhead.

(1) In initialization stage, each client has registered in the server, and the server has the identity information of authorized and registered users. Now the client needs to be authenticated by the server and negotiate the session key with the server. First, the client establishes communication connection with the server and sends an identity authentication request to the server. Different from the traditional authentication method, at this time, the client uses the identity information hiding module to generate false identity information FI and false key parameter information FP_{A}, and transmits the false information in the overt channel. The client uses the covert information embedding module to transmit the true identity information RI of the client in the covert channel. At the same time, in order to prepare for the subsequent key negotiation, the key transmission module generates a key encoding or dividing rule (KDR), which is embedded in the covert channel through the covert information embedding module and then transmitted to the server. The purpose of the above method is to prevent the identity information of a user or an apparatus from being transmitted in an overt channel and reduce the risk of exposure. From the perspective of the attackers, it still appears to be a normal communication process, even if the information is intercepted, it is still false identity information. Even the false identity information may be used to mislead the attackers to complete adversarial attacks on the attackers.

As a further extension, the client can decide on which channel to transmit the true information, and the server only needs to authenticate that the identity of a user is registered after receiving the information, which is more flexible while achieving the same purpose. Unlike the above process where the covert channel is specified to transmit information, which thus may suffer attacks from the attackers by using all resources. The channel for transmitting true information is selected randomly. Even if the attackers have the ability to obtain the information from both channels, the attackers cannot distinguish which one is the true identity information, thus improving the difficulty of intercepting identity information and protecting user privacy. It is worth noting that for the method and the system, the objective of this stage is to protect the user identity information. If overhead needs to be saved and this function is deemed unnecessary, the part of embedding information using the covert channel during this stage may be omitted, and a regular authentication process can still be used. This system supports flexible use of various functions and modules.

(2) Client-server identity authentication stage is used to achieve identity authentication between the client and the server. The server authenticates the identity information of the client after receiving the authentication request, and checks whether the client is registered. If the client is not registered, the client is deemed as an unauthorized user and the authentication fails. If the identity information is valid, the authentication is successful, then the server uses the key transmission module to generate false communication information FKI_{A}, such as a false key and false task information, and transmit the false communication information FKI_{A} in an overt channel to mislead or even induce attackers to carry out adversarial attacks. Moreover, a true key parameter RP_{A} needs to be generated, and then the true key parameter RP_{A} is divided according to the key encoding or dividing rule KDR received from the client before to obtain RP₁ and RP₂. There are various KDR rules, such as bisection division, parity-crossed division and other rules, or it is specified how many bits in a piece of data are true key parameters. The KDR rule can use a small number of bits to indicate the true position of the key parameter. Then RP₁ is transmitted in the overt channel, while RP₂ is transmitted in the covert channel. This is equivalent to transmitting key information in two paths. The attackers need to obtain all the key information of two channels, and then obtain the correct rules for reassembly, splicing and decoding to obtain the true key RP_{A}.

As a further extension, corresponding to the extension part of the previous stage, after successful authentication, the key parameter will be returned from the channel through which the true identity information is authenticated (or correspondingly from the other channel). No specific channel is designated for transmitting specific information, nor the key parameter is divided. The sender of the previous stage is also the receiver of this stage, so that it is easy to know which channel transmits the true information to directly decode the key parameter. The overhead of calculation and determination may be reduced by leveraging the tacit understanding of identity that is authenticated successfully. At the same time, the randomness of channel transmission and the difficulty of cracking the key are increased, because the attackers cannot distinguish which channel has a true key parameter even if the attackers obtain the information from both channels, which can enhance security of key transmission. In this case, the complex unprotected rule KDR will no longer be transmitted, to reduce the amount of unprotected data transmitted in the channel. Similarly, for the method and the system, the purpose of this stage is to protect the key transmission. If overhead needs to be saved, this function in this stage may be omitted, and the key may be transmitted directly in the overt channel.

(3) In key exchange stage, after receiving the key parameters RP₁ and RP₂ from the information decoded and extracted from two channels, the covert information extraction module of the client decodes and recovers the key according to the KDR rule to obtain a key SKᵢ for a subsequent communication session. Next, the important information of SKᵢ is similarly encoded and divided according to the rule KDR to obtain two parts of SK_{i,1} and SK_{i,2}. Then SKᵢ, is transmitted in the overt channel, while SK_{i,2} is transmitted in the covert channel by using the covert information embedding module. Finally, in this stage, the key transmission module of the client further needs to generate a key replacement rule (KR). In the subsequent communication process, when both parties determine that the conditions specified by the KR are satisfied, the two communication parties negotiate replacing the key by using the covert channel. Irregular key replacement can enhance security and reliability of communication, and the process of replacing the key by using the covert channel is not easy to be discovered by attackers. At the same time, the KR replacement conditions may be varied. For example, when important information needs to be transmitted or when a certain amount of data has been transmitted, the key may be replaced.

As a further extension, corresponding to the extension part of the previous stage, the key is not divided using the dividing rule. The key SKᵢ is transmitted in one of the channels, such as, as a comparison, correspondingly returning the key from the channel that received the true and correct parameter information last time (or correspondingly from the other channel). The sender of the previous stage is also the receiver of this stage, so that it is easy to know which channel transmits the true information to directly decode the key. Similarly, for the method and the system, the purpose of this stage is to protect the key transmission. If overhead needs to be saved, this function in this stage may be omitted, and the key may be transmitted directly in the overt channel.

(4) In encrypted communication stage, after receiving all the information, the server restores and splices SK_{i,1} and SK_{i,2} into a communication key SK; according to the KDR rule, or the corresponding extension part directly receives all the keys from one of the channels. Then, the server and the client use SKᵢ as the communication session key to perform encrypted communication transmission on the data in the overt channel. Finally, in this stage, it is necessary to use the continuous authentication module to generate a short tag DRL as a subsequent lightweight authentication identifier.

(5) In continuous authentication stage, after receiving the short tag DRL, the client embeds the short tag in the covert channel for transmitting, and normal data transmission is carried out in the overt channel at the same time. At this time, if an attacker attempts to join in a communication process to carry out man-in-the-middle attack, forgery attack, etc., because the covert channel used by the attacker does not contain the short tag DRL, this attempt is perceived and warned by the continuous authentication module when the attacker establishes communication connection with the client and the server. In this way, the data security of the whole communication process may be guaranteed at a small cost. Similarly, for the method and the system, the purpose of this stage is to ensure the security of the whole communication process by continuous authentication and identification. If overhead is to be saved, the functions in this stage may be omitted, and short tag is not embedded in the covert channel for identification and authentication.

The covert channel method based on the order of the inter-packet delays is introduced hereinafter.

First, it should be emphasized that various technologies for establishing a covert channel may be applied to the above-mentioned identity authentication process. This is not limited to a certain covert channel information embedding method, but may be embedded with various methods to establish a covert channel to embed hidden information. Moreover, the technologies for establishing a covert channel may be flexibly deployed in the covert information embedding module and the covert information extraction module according to different scenes and overhead. The present disclosure puts forward a method of establishing a covert channel based on the order of the inter-packet delays, which does not mean that the above-mentioned identity authentication process must use this method to establish a covert channel to work. The detailed working principle is introduced hereinafter.

$$D = \{ {D}_{0} , {D}_{1} , ⋯ , {D}_{k} , ⋯ , {D}_{m} \} \qquad ( 1 )$$

$$I P D = \{ I P {D}_{0} , I P {D}_{1} , ⋯ , I P {D}_{i} , ⋯ , I P {D}_{j} \} \qquad ( 2 )$$

$$I P {D}^{coded} = \{ I P {D}_{0}^{coded} , I P {D}_{1}^{coded} , ⋯ , I P {D}_{i}^{coded} , ⋯ , I P {D}_{j}^{coded} \} \qquad ( 3 )$$

$$I P {D}^{′} = \{ I P {D}_{1}^{′} , I P {D}_{2}^{′} , ⋯ , I P {D}_{k}^{′} , ⋯ , I P {D}_{m}^{′} \} \qquad ( 4 )$$

$${D}^{decode} = \{ I P {D}_{0}^{decode} , I P {D}_{1}^{decode} , ⋯ , I P {D}_{i}^{decode} , ⋯ , I P {D}_{j}^{decode} \} \qquad ( 5 )$$

The covert channel is established to embed information for transmission data by adjusting the order of the inter-packet delays. The specific workflow is as follows. First, an embedded information stream is converted into a binary code word D as shown in Formula (1); the data packet delay interval sequence IPD is recorded, as shown in Formula (2); and a IPD^{coded} sequence is obtained after encoding, as shown in Formula (3); and finally, a sender sends a data packet according to the time sequence. The receiver records arrival time of the data packet, calculates the sequence IPD′ of the inter-packet delays, as shown in Formula (4), and then obtains a code word D_{decode} according to a decoding rule, as shown in Formula (5), to recover original embedded information. The basic principle of the algorithm proposed in the present disclosure is to divide IPD into a plurality of groups. Each group is embedded with 1 bit of information, that is, 1 code word Dₖ. There are many encoding and grouping methods. The following examples will explain in detail the various encoding and grouping methods, which are subdivided into two parts: a covert channel encoding module and a decoding module.

### (1) Method 1

I. For the encoding module, according to the method 1, the IPD sequence {IPD₀, IPD₁, . . . , IPDᵢ, . . . , IPDⱼ} is divided into groups each consisted of two elements to obtain {IPD₀, IPD₁, . . . , IPD₂ₖ, IPD₂ₖ₊₁, . . . , IPDⱼ}. Each group sequence {IPD₂ₖ, IPD₂ₖ₊₁} embeds a code word DE based on a manner of adjusting the order of elements without changing the packet sending order. Before that, the distance between every two IPDs is increased according to Formula (6), which may better improve the anti-delay jitter performance of the algorithm. When the distance between adjacent IPDs is less than a, the larger IPD of the adjacent IPDs is increased by Δ. Then, according to Formula (7), the order of the inter-packet delays is adjusted to perform encoding operation. If the embedded information is 0, IPD₂ₖ, and IPD₂ₖ₊₁ are compared; and in the case that IPD₂ₖ>IPD₂ₖ₊₁, the order of IPD^{coded} sequence after encoding remains unchanged; and in the case that IPD₂ₖ<IPD₂ₖ₊₁, the orders of two elements are exchanged. If the embedded information is 1, IPD₂ₖ and IPD₂ₖ₊₁ are compared, and in the case that IPD₂ₖ<IPD₂ₖ₊₁, the order of IPD^{coded} sequence after encoding remains unchanged; and in the case that IPD₂ₖ>IPD₂ₖ₊₁, the orders of two elements are exchanged. All code words D are encoded continuously to obtain a IPD^{coded} sequence, and finally the sender sends the data packets according to the interval time of the IPD^{coded} sequence.

$$a > 0 , Δ > 0 , 0 < \vert I P {D}_{2 k} - I P {D}_{2 k + 1} \vert < a , max \{ I P {D}_{2 k} , I P {D}_{2 k + 1} \} = max \{ I P {D}_{2 k} , I P {D}_{2 k + 1} \} + Δ \qquad ( 6 )$$

$$\{ \begin{matrix}If {D}_{k} = 0 and I P {D}_{2 k} > I P {D}_{2 k + 1} , & \{ I P {D}_{2 k}^{coded} , I P {D}_{2 k + 1}^{coded} \} = \{ I P {D}_{2 k} , I P {D}_{2 k + 1} \} \\ If {D}_{k} = 0 and I P {D}_{2 k} > I P {D}_{2 k + 1} , & \{ I P {D}_{2 k}^{coded} , I P {D}_{2 k + 1}^{coded} \} = \{ I P {D}_{2 k + 1} , I P {D}_{2 k} \} \\ If {D}_{k} = 0 and I P {D}_{2 k} > I P {D}_{2 k + 1} , & \{ I P {D}_{2 k}^{coded} , I P {D}_{2 k + 1}^{coded} \} = \{ I P {D}_{2 k} , I P {D}_{2 k + 1} \} \\ If {D}_{k} = 0 and I P {D}_{2 k} > I P {D}_{2 k + 1} , & \{ I P {D}_{2 k}^{coded} , I P {D}_{2 k + 1}^{coded} \} = \{ I P {D}_{2 k + 1} , I P {D}_{2 k} \}\end{matrix} \} \qquad ( 7 )$$

II. For decoding module, the arrival times of the data packets are recorded to obtain the sequence IPD′. Two adjacent IPD's are compared, and if

$$I P {D}_{2 k - 1}^{′} > I P {D}_{2 k}^{′} , {D}_{k}^{decode} = 0 , and if I P {D}_{2 k - 1}^{′} < I P {D}_{2 k}^{′} , {D}_{k}^{decode} = 1.$$

Decoding is performed according to Formula (8) and Formula (9) to obtain a code word

$${D}^{decode} .$$

$$I P {D}^{′} = \{ I P {D}_{1}^{′} , I P {D}_{2}^{′} , … , I P {D}_{k}^{′} , … , I P {D}_{m}^{′} \} \qquad ( 8 )$$

$$\{ \begin{matrix}If I P {D}_{2 k}^{′} > I P {D}_{2 k + 1}^{′} , & {D}_{k}^{decode} = 0 \\ If I P {D}_{2 k}^{′} < I P {D}_{2 k + 1}^{′} , & {D}_{k}^{decode} = 1\end{matrix} \} \qquad ( 9 )$$

### (2) Method 2

I. For encoding module, according to the method 2, the IPD sequence {IPD₀, IPD₁, . . . , IPDᵢ, . . . , IPDⱼ} is divided into groups each consisted of three elements to obtain {IPD₀, IPD₁, IPD₂, . . . , IPD₃ₖ, IPD₃ₖ₊₁, IPD₃ₖ₊₂, . . . , IPDⱼ}. Each group sequence {IPD₃ₖ, IPD₃ₖ₊₁, IPD₃ₖ₊₂} embeds a code word DE based on a manner of adjusting the order of elements. Before that, the three elements in each group are sorted in a descending order to obtain {IPDₘₐₓ, IPD_{middle}, IPDₘᵢₙ}, and then the distance between IPDs is increased according to Formula (10), which also increases the distance between a maximum value and a minimum value in a group using the operation of increasing IPDₘₐₓ by Δ, thus improving the anti-delay jitter performance of the algorithm. Then, according to Formula (11), the order of the inter-packet delays is adjusted to perform encoding operation. If the embedded information is 0, the orders of elements are exchanged so as to be {IPDₘₐₓ, IPDₘᵢₙ, IPD_{middle}}. If the embedded information is 1, the orders of elements are exchanged so as to be {IPDₘᵢₙ, IPDₘₐₓ, IPD_{middle}}. It is worth noting that placing IPDₘₐₓ and IPDₘᵢₙ in the adjacent positions can make full use of their distance to resist jitter. If the network state is good, or the operation of Formula (8) may be omitted, the encoding and embedding overhead is saved. All code words D are encoded continuously to obtain an IPD sequence, and finally the sender sends the data packets according to the interval time of the IPD^{coded} sequence.

$$a > 0 , Δ > 0 , 0 < I P {D}_{max} - I P {D}_{min} < a , I P {D}_{max} = I P {D}_{max} + Δ \qquad ( 10 )$$

$$\{ \begin{matrix}If {D}_{k} = 0 , & \{ I P {D}_{3 k}^{coded} , I P {D}_{3 k + 1}^{coded} , I P {D}_{3 k + 2}^{coded} \} = \{ I P {D}_{max} , I P {D}_{min} , I P {D}_{middle} \} \\ If {D}_{k} = 1 , & \{ I P {D}_{3 k}^{coded} , I P {D}_{3 k + 1}^{coded} , I P {D}_{3 k + 2}^{coded} \} = \{ I P {D}_{max} , I P {D}_{min} , I P {D}_{middle} \}\end{matrix} \} \qquad ( 11 )$$

II. For decoding module, the arrival times of the data packets are recorded to obtain the sequence IPD′. The IPD′ sequence is divided into groups each consisted of three elements. IPD's in each group are compared, and if

$${IPD}_{3 k}^{′} > {IPD}_{3 k + 2}^{′} , {D}_{k}^{decode} = 0 , and if {IPD}_{3 k}^{′} < {IPD}_{3 k + 2}^{′} ,$$

$${D}_{k}^{decode} = 1.$$

Decoding is performed according to Formula (12) to obtain a code word

$${D}^{decode} .$$

$$\{ \begin{matrix}If {IPD}_{3 k}^{′} > {IPD}_{3 k + 2}^{′} , {D}_{k}^{decode} = 0 \\ If {IPD}_{3 k}^{′} < {IPD}_{3 k + 2}^{′} , {D}_{k}^{decode} = 1\end{matrix} \} \qquad ( 12 )$$

### (3) Method 3

I. For encoding module, according to the method 3, the IPD sequence {IPD₀, IPD₁, . . . , IPDᵢ, . . . , IPDⱼ} is also divided into groups each consisted of three elements to obtain {IPD₀, IPD₁, IPD₂, . . . , IPD₃ₖ, IPD₃ₖ₊₁, IPD₃ₖ₊₂, . . . , IPDⱼ}. Each group sequence {IPD₃ₖ, IPD₃ₖ₊₁, IPD₃ₖ₊₂} embeds a code word DE based on a manner of adjusting the order of elements. Before that, the three elements in each group are sorted in a descending order to obtain {IPDₘₐₓ, IPD_{middle}, IPDₘᵢₙ}, and then the distance between IPDs is increased according to Formula (13), which also increases the distance between a maximum value and a minimum value in a group using the operation of increasing IPDₘₐₓ by Δ, thus improving the anti-delay jitter performance of the algorithm. Then, according to Formula (14), the order of the inter-packet delays is adjusted to perform encoding operation. If the embedded information is 100, the orders of elements are exchanged so as to be {IPDₘₐₓ, IPD_{middle}, IPDₘᵢₙ}. If the embedded information is 001, the orders min of elements are exchanged so as to be {IPDₘᵢₙ, IPD_{middle}, IPDₘₐₓ}. If the embedded information is 010, the orders of elements are exchanged so as to be {IPDₘᵢₙ, IPDₘₐₓ, IPD_{middle}}. All code words D are encoded continuously to obtain an IPD sequence, and finally the sender sends the data packets according to the interval time of the IPD^{coded} sequence.

$$a > 0 , Δ > 0 , 0 < {IPD}_{max} - {IPD}_{min} < a , \qquad ( 13 )$$

$${IPD}_{max} = {IPD}_{max} + Δ$$

$$\{ \begin{matrix}If {D}_{k} = 100 , \{ {IPD}_{3 k}^{coded} , {IPD}_{3 k + 1}^{coded} , {IPD}_{3 k + 2}^{coded} \} = \{ {IPD}_{max} , {IPD}_{middle} , {IPD}_{min} \} \\ If {D}_{k} = 001 , \{ {IPD}_{3 k}^{coded} , {IPD}_{3 k + 1}^{coded} , {IPD}_{3 k + 2}^{coded} \} = \{ {IPD}_{min} , {IPD}_{middle} , {IPD}_{max} \} \\ If {D}_{k} = 010 , \{ {IPD}_{3 k}^{coded} , {IPD}_{3 k + 1}^{coded} , {IPD}_{3 k + 2}^{coded} \} = \{ {IPD}_{min} , {IPD}_{max} , {IPD}_{middle} \}\end{matrix} \} \qquad ( 14 )$$

II. For decoding module, the arrival time of the data packets are recorded to obtain the sequence IPD′. The IPD′ sequence is divided into groups each consisted of three elements. IPD's

$${IPD}_{3 k}^{′} > {IPD}_{3 k + 1}^{′} > {IPD}_{3 k + 2}^{′} , {D}_{k}^{decode} = 100.$$

$$If {IPD}_{3 k}^{′} < {IPD}_{3 k + 1}^{′} < {IPD}_{3 k + 2}^{′} , {D}_{k}^{decode} = 1.$$

$$If {IPD}_{3 k}^{′} < {IPD}_{3 k + 1}^{′} and {IPD}_{3 k + 1}^{′} > {IPD}_{3 k + 2}^{′} , {D}_{k}^{decode} = 10.$$

in each group are compared. If Decoding is performed according to Formula (15) to obtain a code word

$${D}^{decode} .$$

$$\{ \begin{matrix}If {IPD}_{3 k}^{′} > {IPD}_{3 k + 1}^{′} and {IPD}_{3 k}^{′} > {IPD}_{3 k + 2}^{′} , & {D}_{k}^{decode} = 100 \\ If {IPD}_{3 k + 2}^{′} > {IPD}_{3 k + 1}^{′} and {IPD}_{3 k + 2}^{′} > {IPD}_{3 k}^{′} , & {D}_{k}^{decode} = 001 \\ If {IPD}_{3 k + 1}^{′} > {IPD}_{3 k}^{′} and {IPD}_{3 k + 1}^{′} > {IPD}_{3 k + 2}^{′} , & {D}_{k}^{decode} = 010\end{matrix} \} \qquad ( 15 )$$

The corresponding method of embedded information in Method 3 is not invariable. The set of embedded information in Formula (14) is {100,010,001}, or the user can select the encoding set as {110,011,001}, perform encoding according to Formula (16), and finally perform decoding according to the size of the IPD sequence at the receiver.

$$\{ \begin{matrix}If {D}_{k} = 110 , \{ {IPD}_{3 k}^{coded} , {IPD}_{3 k + 1}^{coded} , {IPD}_{3 k + 2}^{coded} \} = \{ {IPD}_{max} , {IPD}_{middle} , {IPD}_{min} \} \\ If {D}_{k} = 011 , \{ {IPD}_{3 k}^{coded} , {IPD}_{3 k + 1}^{coded} , {IPD}_{3 k + 2}^{coded} \} = \{ {IPD}_{min} , {IPD}_{middle} , {IPD}_{max} \} \\ If {D}_{k} = 010 , \{ {IPD}_{3 k}^{coded} , {IPD}_{3 k + 1}^{coded} , {IPD}_{3 k + 2}^{coded} \} = \{ {IPD}_{min} , {IPD}_{max} , {IPD}_{middle} \}\end{matrix} \} \qquad ( 16 )$$

The difference between Method 2 and Method 3 is that Method 2 encodes one bit with three IPD delays, while Method 3 encodes three bits with three IPD delays. The encoding efficiency is not the same, so that the number of data packets in the required data stream is also different. It may be extended to the grouping method with a group size of n for encoding, and there are also two corresponding encoding methods, which will be described in detail below.

### (4) Method 4

I. For encoding module, according to the method 4, the IPD sequence {IPD₀, IPD₁, . . . , IPDᵢ, . . . , IPDⱼ} is divided into groups each consisted of n elements to obtain {IPD₀, IPD₁, . . . , IPDₙ₋₁, . . . , IPDₙₖ, IPDₙₖ₊₁, . . . , IPDₙ₍ₖ₊₁₎₋₁, IPDⱼ}. Each group sequence {IPDₙₖ, IPDₙₖ₊₁, . . . , IPDₙ₍ₖ₊₁₎₋₁} embeds a code word Dₖ based on a manner of adjusting the order of elements. Before that, the n elements in each group are sorted in a descending order to obtain {IPD₁, IPD₂, . . . , IPDₙ)}. It is worth mentioning that it is obvious that the distance between the maximum IPD and the minimum IPD will theoretically gradually increase with the increase of the size of each group. Therefore, in some cases, the greater the n, the better the anti-jitter performance, but this cannot be infinitely increased but kept in a certain range. Therefore, the number n of elements in one group is not the greater the better. The greater the n, the lower the encoding efficiency, and the higher the encoding overhead. After grouping, the distance between IPDs is still increased according to Formula (17), which also uses the method of increasing the distance between a maximum value and a minimum value in a group to improve the anti-delay jitter performance of the algorithm. Then, according to Formula (18), the order of the inter-packet delays is adjusted to perform encoding operation. If the embedded information is 0, the orders of elements are exchanged so as to be {IPD₁, IPDₙ, . . . , IPD₁₋₁, IPD₂}. If the embedded information is 1, the orders of elements are exchanged so as to be

$$\{ {IPD}_{n} , {IPD}_{1} , … , {IPD}_{n - 1} , {IPD}_{2} \} .$$

$$a > 0 , Δ > 0 , 0 < \vert {IPD}_{1} - {IPD}_{n} \vert < a , \qquad ( 17 )$$

$$max \{ {IPD}_{1} , {IPD}_{n} \} = max \{ {IPD}_{1} , {IPD}_{n} \} + Δ$$

$$\{ \begin{matrix}If {D}_{k} = 0 , \\ \{ {IPD}_{1}^{coded} , … , {IPD}_{n}^{coded} \} = \{ {IPD}_{1} , {IPD}_{n} , {IPD}_{2} , {IPD}_{3} , {IPD}_{4} , {IPD}_{5} , … \} \\ If {D}_{k} = 1 , \\ \{ {IPD}_{1}^{coded} , … , {IPD}_{n}^{coded} \} = \{ {IPD}_{n} , {IPD}_{1} , {IPD}_{2} , {IPD}_{3} , {IPD}_{4} , {IPD}_{5} , … \}\end{matrix} \} \qquad ( 18 )$$

It is worth noting that placing IPD₁ and IPDₙ in the adjacent positions can make full use of their distance to resist jitter. If the network state is poor, in order to save the encoding overhead, embedding may be performed in pairs according to watermark information when exchanging the orders of elements. If the embedded information is 0, the orders of elements are exchanged so as to be as expressed in Formula (19). If the embedded information is 1, the orders of elements are exchanged so as to be as expressed in Formula (20). All code words D are encoded continuously to obtain an IPD sequence, and finally the sender sends the data packets according to the interval time of the IPD^{coded} sequence.

$$\{ {IPD}_{1}^{coded} , … , {IPD}_{n}^{coded} \} = \{ {IPD}_{1} , {IPD}_{n} , {IPD}_{2} , {IPD}_{n - 1} , {IPD}_{3} , {IPD}_{n - 2} , … \} \qquad ( 19 )$$

$$\{ {IPD}_{1}^{coded} , … , {IPD}_{n}^{coded} \} = \{ {IPD}_{n} , {IPD}_{1} , {IPD}_{n - 1} , {IPD}_{2} , {IPD}_{n - 2} , {IPD}_{3} , … \} \qquad ( 20 )$$

II. For decoding module, the arrival times of the data packets are recorded to obtain the sequence IPD′. The IPD′ sequence is divided into groups each consisted of n elements. IPD's in each group are compared, and if

$${IPD}_{1}^{′} > {IPD}_{n}^{′} , {D}_{k}^{decode} = 0 ; and if {IPD}_{1}^{′} < {IPD}_{n}^{′} ,$$

$${D}_{k}^{decode} = 1.$$

Decoding is performed according to Formula (21) to obtain a code word

$${D}^{decode} .$$

$$\{ \begin{matrix}If {IPD}_{1}^{′} > {IPD}_{n}^{′} , & {D}_{k}^{decode} = 0 \\ If {IPD}_{1}^{′} < {IPD}_{n}^{′} , & {D}_{k}^{decode} = 1\end{matrix} \} \qquad ( 21 )$$

In addition, the decoding method corresponding to the encoding methods of Formula (19) and Formula (20) is Formula (21), and n IPD′ in each group sequence is divided into subgroups each consisted of two elements that are compared to each other, and if in most of subgroups, the former elements is greater than the latter element,

$${D}_{k}^{decode} = 0 ;$$

and if in most of subgroups, the former element is smaller than the latter element,

$${D}_{k}^{decode} = 1 .$$

Decoding is performed according to Formula (22) to obtain a code word D^{decode}.

To sum up, Method 4 is the popularization and application of Method 1 and Method 2. If n=2, it is equivalent to encoding and decoding in Method 1, and the encoding set is {0,1}. If n=3, it is equivalent to the encoding and decoding in Method 2, and the encoding set is also {0,1}.

$$\{ \begin{matrix}If {IPD}_{1}^{′} > {IPD}_{n}^{′} and {IPD}_{2}^{′} > {IPD}_{n - 1}^{′} and … , {D}_{k}^{decode} = 0 \\ If {IPD}_{1}^{′} < {IPD}_{n}^{′} and {IPD}_{2}^{′} < {IPD}_{n - 1}^{′} and … , {D}_{k}^{decode} = 1\end{matrix} \} \qquad ( 22 )$$

### (5) Method 5

For encoding and decoding module, according to the Method 5, the IPD sequence {IPD₀, IPD₁, . . . , IPDᵢ, . . . , IPDⱼ} is divided into groups each consisted of n elements to obtain {IPD₀, IPD₁, . . . , IPDₙ₋₁, . . . , IPDₙₖ, IPDₙₖ₊₁, . . . , IPDₙ₍ₖ₊₁₎₋₁, IPDⱼ}. Each group sequence {IPDₙₖ, IPDₙₖ₊₁, . . . , IPDₙ₍ₖ₊₁₎₋₁} embeds a code word Dₖ based on a manner of adjusting the order of elements. Before that, the n elements in each group are sorted in a descending order to obtain {IPD₁, IPD₂, . . . , IPDₙ}. The Method 5 is the popularization and application of the above methods. If n=3, it is equivalent to the encoding and decoding in Method 3. The encoding set is determined by the user as {100,010,001} or {011,101,110}, and the number of encoding elements is

$${C}_{3}^{1} .$$

Every n elements form a group, so that it is necessary to determine the encoding set first, and then adjust the order encoding information to perform encoding operation. For example, if n=5, and the number of encoding elements is

$${C}_{5}^{1} ,$$

the encoding set may be {10000,01000,00100,00010,00001}, where “1” is the position of the largest IPD in each group, or the encoding set may be {01111,10111, 11011, 11101, 11110}, where “O” is the position of the smallest IPD in each group. Decoding is also performed by comparing the sizes of elements according to the regulations during encoding, which will not be described in detail here. If n=5, and the number of encoding elements is

$${C}_{5}^{2} ,$$

the encoding set may be {11000,10100,10010, 10001,01100,01010,01001,00110,00101,00011}, where the first “1” is the largest IPD in each group, the second “1” is the position of the second largest IPD in each group. The also encoding set may be {00111,01011,01101,01110,10011,10101,10110,11001,11010,11100}, where the first “O” is the position of the smallest IPD in each group, and the second “0” is the position of the second smallest IPD in each group. Similarly, it may be seen that decoding is also performed by comparing the sizes of elements according to the regulations during encoding, which will not be described in detail here.

The application scenes of the present disclosure will be described below by way of example.

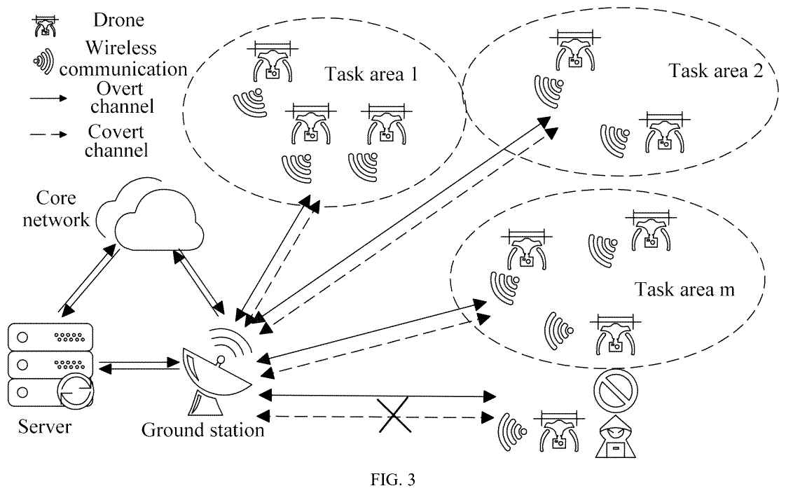

With the development of smart city construction and low-altitude economy, a drone will play an indispensable role, so that the secure identity authentication of the drone becomes particularly important. The present disclosure may be applied to the identity authentication of the drone and the ground station, as shown in FIG. 3. A smart city is divided into a plurality of task execution areas. A plurality of drones may be deployed in one task execution area. As the control center and data center, the ground station is responsible for communicating with all drones, and the server is responsible for storing all necessary data. The patent is applicable to the scenes that all authorized drones are authenticated by the ground station. The drone may be used as the client of the present disclosure, and the ground station may be used as the server of the present disclosure for identity authentication.

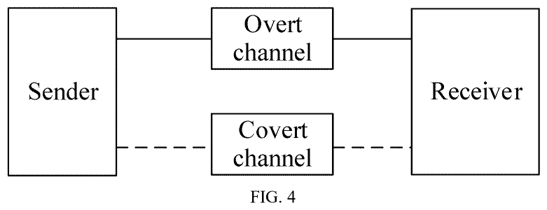

The existing computer networks all use an overt channel for communication, and even if encryption is used, both communication parties are vulnerable to attacks due to the openness. Especially in a P2P network, attackers may eavesdrop and intercept the user identity, and then use forged and hijacked information to communicate with a target. The sender and the receiver on the FTP platform deploy the identity authentication mechanism of the present disclosure, introduce a covert channel to embed important authentication information to protect information privacy of user identity, and at the same time, can prevent attackers from eavesdropping, provide highly reliable identity authentication, and provide security of the whole communication process by using the short tag continuous authentication method of the present disclosure, as shown in FIG. 4.

What has been described above is only the preferred embodiment of the present disclosure, which is not used to limit the present disclosure. For those skilled in the art, the present disclosure may have various modifications and changes. Any modification, equivalent substitution, improvement, etc. made within the spirit and the principle of the present disclosure should be included in the scope of protection of the present disclosure.

What is claimed is:

1. An identity authentication method based on a covert channel, comprising:
step 1: dividing or performing confused transmission on user identity information configured for authentication in the covert channel and an overt channel, and generating misleading forged identity information for transmission in the covert channel and the overt channel;
step 2: dividing a key, and transmitting partial divided keys in the covert channel and the overt channel, respectively; and
step 3: in an encrypted communication stage, embedding short tag information in the covert channel to continuously authenticate a client.

2. The identity authentication method based on the covert channel according to claim 1, further comprising performing the step 2 to renegotiate about replacing the key, and then performing the step 3.

3. The identity authentication method based on the covert channel according to claim 1, wherein the step 2 comprises a method of constructing the covert channel based on an order of inter-packet delays, wherein the method of constructing the covert channel based on the order of the inter-packet delays comprises:
converting an embedded information stream into binary code words, recording a data packet delay interval sequence, encoding the data packet delay interval sequence to obtain a time sequence, and sending data packets according to the time sequence by a sender; and
recording, by a receiver, arrival times of the data packets, calculating a sequence of the inter-packet delays, and then obtaining code words according to a decoding rule to recover original embedded information.

4. The identity authentication method based on the covert channel according to claim 3, wherein the method of constructing the covert channel based on the order of the inter-packet delays further comprises encoding the data packet delay interval sequence in groups, wherein each group is embedded with 1 bit of information, and the 1 bit of information is 1 code word.

5. An identity authentication apparatus based on a covert channel, comprising an identity authentication client and an identity authentication server, wherein the covert channel and an overt channel are constructed between the identity authentication client and the identity authentication server;
the covert channel and the overt channel are configured to transmit user identity information for authentication and misleading forged identity information, and transmit divided keys, respectively; and
the covert channel is further configured to transmit short tag information for continuous authentication.

6. The identity authentication apparatus based on the covert channel according to claim 5, wherein the identity authentication client and the identity authentication server each comprise an identity information hiding module, a key transmission module, a continuous authentication module, a covert information embedding module, and a covert information extraction module;
the identity information hiding module, the key transmission module, and the continuous authentication module are configured for generating required corresponding information, determining which channel to be used for transmitting the required corresponding information and a next task execution scheme after receiving the required corresponding information; and the covert information embedding module is configured to embed the required corresponding information into the covert channel, and the covert information extraction module is configured to extract the required corresponding information from the covert channel; and
the identity information hiding module is configured to generate false identity information and false key parameter information and generate a key encoding or dividing rule.

7. The identity authentication apparatus based on the covert channel according to claim 6, wherein the identity authentication client and the identity authentication server cooperate through the following steps to complete identity authentication:
in an initialization stage, establishing, by the identity authentication client, communication connection with the identity authentication server, sending an identity authentication request to the identity authentication server, transmitting the user identity information for the authentication by using the covert information embedding module in the covert channel, and transmitting the false identity information forged by the identity information hiding module and the false key parameter information in the overt channel; wherein one from the overt channel and the covert channel is randomly selected to transmit true identity information or the false identity information, and the identity authentication server only authenticates a piece of complete true identity information;
in an identity authentication stage for achieving the identity authentication between the identity authentication client and the identity authentication server, authenticating, by the identity authentication server, the user identity information of the identity authentication client after receiving the identity authentication request, and checking whether the identity authentication client is registered, wherein in response to the identity authentication client being not registered, deeming the identity authentication client as an unauthorized user and rejecting the authentication; and in response to the user identity information being valid, passing the authentication, then generating, by the identity authentication server, false communication information and a true key parameter using the key transmission module, and then dividing the true key parameter according to the key encoding or dividing rule received from the identity authentication client before to obtain two divided key parameters for transmission;
in a key exchange stage, after receiving the two divided key parameters from the covert channel and the overt channel, decoding and recovering, by the identity authentication client, the two divided key parameters according to the key encoding or dividing rule to obtain a communication session key for a subsequent communication session; wherein the communication session key for the subsequent communication session is divided according to the key encoding or dividing rule to obtain two divided communication session keys, and the two divided communication session keys are transmitted in the overt channel and the covert channel, respectively; and
in an encrypted communication stage, after receiving all information, restoring and splicing, by the identity authentication server, the two divided communication session keys into a communication key according to the key encoding or dividing rule; and then, using, by the identity authentication server and the identity authentication client, the communication key as the communication session key to perform encrypted communication transmission on data in the overt channel.

8. The identity authentication apparatus based on the covert channel according to claim 7, wherein in the encrypted communication stage, the continuous authentication module is further configured to generate a short tag as a subsequent authentication identifier, and then upon entering a continuous authentication stage, the identity authentication client is configured to, after receiving the short tag, embed the short tag in the covert channel for transmitting, and transmit the data in the overt channel at the same time; and the continuous authentication module is configured to, in a case that an attacker attempts to join in a communication process to carry out man-in-the-middle attack or forgery attack, perceive and warn an attempt when the attacker establishes communication connection with the identity authentication client and the identity authentication server, since the covert channel used by the attacker does not contain the short tag.

9. The identity authentication apparatus based on the covert channel according to claim 5, wherein an information transmission path is changed to a situation, wherein in the situation, the overt channel is configured to transmit the user identity information for the authentication and the covert channel is configured to transmit the misleading forged identity information.

10. The identity authentication apparatus based on the covert channel according to claim 5, wherein the identity authentication apparatus is applied to the authentication in a drone or a File Transfer Protocol (FTP) platform.

11. The identity authentication apparatus based on the covert channel according to claim 6, wherein the identity authentication apparatus is applied to the authentication in a drone or an FTP platform.

12. The identity authentication apparatus based on the covert channel according to claim 7, wherein the identity authentication apparatus is applied to the authentication in a drone or an FTP platform.

13. The identity authentication apparatus based on the covert channel according to claim 8, wherein the identity authentication apparatus is applied to the authentication in a drone or an FTP platform.

14. The identity authentication apparatus based on the covert channel according to claim 9, wherein the identity authentication apparatus is applied to the authentication in a drone or an FTP platform.
